(19) United States
(12) Patent Application Publication
(10) Pub. No.: US 2012/0125061 A1
(43) Pub. Date: May 24, 2012

(54) LINKAGE ANTI-THEFT LOCK HEAD

(75) Inventors: Changluo Zhu, Pingdingshan (CN); Jiekuan Sun, Pingdingshan (CN); Mu Lin, Pingdingshan (CN); Jiquan Yu, Pingdingshan (CN)

(73) Assignee: PINGDINGSHAN DAHAN LOCK CO., LTD., Pingdingshan (CN)

(21) Appl. No.: 13/386,575

(22) PCT Filed: Feb. 20, 2010
(86) PCT No.: PCT/CN2010/000226

§ 371 Date: Jan. 23, 2012

(30) Foreign Application Priority Data
Jul. 24, 2009 (CN) 200910065521.4
Oct. 13, 2009 (CN) 200920224081.8

(51) Int. Cl. E05B 29/04; E05B 73/00

(52) U.S. Cl. 70/351

(57) ABSTRACT

A linkage anti-theft lock head comprises a lock tube (16), a lock core (2), a brake bar (19), a front tumbler (6) with its return spring (20), a rear tumbler (9) with its return spring (20) and a key (1). Clearance fits are provided between the front tumbler (6) and the rear tumbler (9) with the holes (26) distributed axially on the lock core (2). The brake bar (19) is mounted axially along the lock core (2). Brake teeth of the brake bar (19) engage with the teeth grooves of the front tumbler (6) and the rear tumbler (9). Said engagement is a linkage engagement. A brake groove (17) is set on the lock tube (16) to match with the brake bar (19). The tumblers, the brake bar (19) and the lock core (2) constitute a cant device, wherein the front tumbler (6) and the rear tumbler (9) act as moving cams set oppositely, the brake bar (19) acts as a driven member and the lock core (2) acts as a rack.

### FIELD OF THE INVENTION

The present invention relates to an anti-theft lock head and in particular, to an anti-theft lock head with linkage unlocking and locking.

### DESCRIPTION OF THE PRIOR ART

A tumbler type anti-theft lock (Patent Application No.: 200710160958.7 and Publication No.: CN101196085). The way to unlock and lock it is that during the insertion process of a key, the tumblers inside the lock head completely disengage from the locking state along with the insertion of the key and enter a rotation interface of the lock core. At this time, however, the lock core is unable to rotate just because the tumblers disengage from the locking state. The key must drive a round controlling plate to rotate such that the round controlling plate pushes a boss at the end of a guide rod backwardly for axial displacement, disengages from the groove on the lock tube, and then only through the mesh between the guide rod brake teeth on the guide rod and the tooth grooves on the tumblers, can the lock core be completely placed in an unlocking state. During the process to pull out the key, the key is first returned to the pulling position, the guide rod moves forwardly and axially by means of a spring at the back end thereof such that the guide rod brake teeth on the guide rod disengage from the tooth grooves on the tumblers, subsequently the boss on the guide rod enters the groove on the lock tube and forms a primary locking. Only at this moment can the key be pulled out. When the key is pulled sequentially out of keyholes of the tumblers, each tumbler disengages from the mesh with the guide rod brake tooth at this moment and returns to the locking position by means of the spring, which is the secondary locking.

Although said tumbler type anti-theft lock has superior anti-theft performance, it still has the following technical drawbacks:
1. Compared with conventional pin tumbler locks and tumbler locks, it has an additional secondary locking capability; in terms of the tumblers themselves, however, there is no difference from conventional tumbler locks in locking and unlocking, i.e. unlocking with a key and the tumbler returning to the locking position by means of a spring or a guide groove on the key in the process of pulling out the key.
2. Since the tumbler and the guide rod are locked separately, the two are meshed through a round controlling plate. In essence, however, the two carry out their respective locking functions separately. There is only a passive brake relationship between the two with no brake relationship through linkage. This is a weak spot in the anti-theft technology that could leave room for technical unlocking operations.
3. In either conventional pin tumbler locks and tumbler locks or said tumbler type anti-theft lock, the key only plays a role of unlocking in the unlocking and locking process. The realization of secondary locking through key linkage is another technical field to be developed to further improve a lock head's anti-theft performance.
4. The complex structure will surely increase the mould cost and the processing difficulty and leads to a number of extra functions according to value engineering analysis. For example, double guide rods, double guide rod swallowtail-shaped grooves, two-end tumbler tooth grooves and double guide rod return springs can be changed to single guide rods, single guide rod swallowtail-shaped groove, single-end tumbler tooth groove and single guide rod return spring.

### SUMMARY OF THE INVENTION

The object of the present invention is to provide an anti-theft lock head with linkage unlocking and locking, inside which secondary unlocking and secondary locking are realized through a linkage structure. While further improving the lock head's anti-theft performance, it avoids extra functions and simplifies the structure.

To attain the above object, the present invention employs the following technology:

A linkage anti-theft lock head, comprising a lock tube, a lock core, a brake bar, a front tumbler with its return spring, a rear tumbler with its return spring and a key. Clearance fits are provided between said front tumbler and the rear tumbler and the tumbler holes distributed axially on the lock core, said brake bar is mounted axially along the lock core thereof, brake teeth of the brake bar engage with the tooth grooves of the front tumbler and the rear tumbler. A mobile cam device is formed with the front tumbler and the rear tumbler acting as moving cams set oppositely, the brake bar acting as a driven member and the lock core acting as a rack. The brake teeth of the tooth grooves of the front tumbler and the rear tumbler are engaged to form a linkage engagement, and a brake groove is formed on the lock tube to engage with the brake bar. In such a circumstance, there are two ways of embodiments:

(1) The front tumblers are the preceding tumblers and the rear tumbler is the last tumbler. It can be described in detail that it comprises a lock tube, a lock core, a brake bar, preceding tumblers, a last tumbler and a key. A plurality of holes are distributed intervally and axially on the lock core, keyholes are formed on the center of the tumblers, clearance fits are provided between the tumblers and the tumbler holes on the lock core, a lock core groove is formed axially on the top portion of the lock core to form clearance fit with the brake bar, and a boss is formed on the front end of said brake bar for engaging with the circumferential groove on the front end of the lock tube;

All tumblers in front of the last tumbler are preceding tumblers, at least one tooth groove is formed on the front or the back of each preceding tumbler. On the preceding tumbler, the upper inclined plane of the tooth groove forms an angle with the bottom plane of the tooth groove, and the opening of the tooth groove of the preceding tumbler is in the same direction as the key insertion direction; preceding brake teeth are distributed intervally and longitudinally on the brake bar to engage with the tooth grooves on the preceding tumblers;

At least one tooth groove is formed on the front or the back of the last tumbler. On the last tumbler, the upper inclined plane of the tooth groove forms an angle with the bottom plane of the tooth groove, and the opening of the tooth groove of the last tumbler is in the reverse direction as the key insertion direction; a last brake tooth is formed on the brake bar; the shape of one end of said last brake tooth is the same as that of the preceding brake teeth and engages with the tooth groove on the neighboring preceding tumbler, while the other end thereof has a lobe formed by the upper inclined plane and the lower inclined plane for engagement with the tooth groove of the last tumbler;

A brake end is formed on the last position of the above brake bar, which engages with the brake groove on the bottom end of the lock tube;

The above key teeth are formed by transition platforms, a pushing ramp and a back-pressure ramp, and transition connection is formed between the transition platforms and the pushing ramp and the back-pressure ramp; the longitudinally advancing length of any transition platform needs to satisfy the contour advancing length of other transition platforms in the advancing process to prop against the pressing surface of the keyhole on the tumbler; the entire key has at least one back-pressure ramp and the height of the back-pressure ramp equals the height of the preceding brake tooth or the sum of the heights of progressive back-pressure ramps; the front end of the key is provided with a pushing ramp; the key is coded according to the heights of transition platforms.

The tooth grooves of the above preceding tumblers have a right-angled triangle shape formed by the upper inclined plane and the bottom plane of the tooth groove; the horizontal width of said preceding brake tooth is greater than or equal to the horizontal width of the tumbler, and the upper inclined plane of the preceding brake tooth forms an angle with the bottom plane of the brake bar; the tooth groove of said last tumbler has a shape of isosceles triangle, its upper inclined plane and lower inclined plane are symmetrical according to the angular bisector, and said angular bisector is parallel to the bottom plane of the brake bar.

The angle between the upper inclined plane of the above tooth groove of the preceding tumbler and the bottom plane of the tooth groove is 43°˜60°, the angle formed by the upper inclined plane of the above preceding brake tooth and the bottom plane of the brake bar is 30°˜60°, and the bottom plane of the brake bar is parallel to the bottom plane of the tooth groove; the tooth groove of the above last tumbler has a shape of isosceles triangle, the angles formed by its upper and lower inclined planes and the angular bisector are 43°˜60°; the angle between the upper inclined plane and the bottom plane of the end of said last brake tooth of the brake bar facing the preceding tumbler is 30°˜60°, and the angles between the upper and lower inclined planes of the end of said last brake tooth of the brake bar facing the last tumbler that form the lobe and the angular bisector are 30°˜60°.

The angle between the upper inclined plane of the above tooth groove of the preceding tumbler and the bottom plane of the tooth groove is 45°, and the angle formed by the upper inclined plane of the above preceding brake tooth and the bottom plane of the brake bar is 45°; the tooth groove of the above last tumbler has a shape of isosceles triangle, the angles formed by its upper and lower inclined planes and the angular bisector are 45°; the angle between the upper inclined plane and the bottom plane of the end of said last brake tooth of the brake bar facing the preceding tumbler is 45°, and the angles between the upper and lower inclined planes of the end of said last brake tooth of the brake bar facing the last tumbler that form the lobe and the angular bisector are 45°.

The front end of the key is a pushing ramp smaller than or equal to 45°.

Each of the above preceding tumblers is provided with at least 2 tooth grooves that are uniformly arranged in parallel from up down, and the tooth grooves have the same direction, size and angle; in the unlocking state, the bottom plane of one of the tooth grooves on each preceding tumbler is on the same plane as the bottom plane of the preceding brake tooth of the brake bar.

All transition platforms of the above key are parallel to each other and parallel to the axis of the lock core.

Given such a technical embodiment, steps to unlock and lock the linkage anti-theft lock head are, respectively:

The unlocking steps are as follows:
a. The process to unlock the preceding tumblers: the key is pushed forward. When the pushing ramp on the front end of the key props against the pressing surface of the keyhole on the last tumbler, all pressing surfaces of keyholes on the preceding tumblers are in the unlocking state of being pressed by transition platforms of the key, thereby achieving the primary unlocking of the preceding tumblers without linkage;
b. The process to unlock the last tumbler: the key is further pushed forward, and the pushing ramp on the front end of the key completes the process from propping against the pressing surface of the keyhole on the last tumbler to the complete pressing of the pressing surface of the keyhole on the last tumbler by a transition platform, such that the last tumbler moves downward and unlocks;
c. The process to unlock the brake bar: through the movement of the last tumbler, at the same time, the upper inclined plane of the tooth groove on the last tumbler acts like a lug of a moving cam, the lug of said moving cam presses downwardly the upper inclined plane of the lobe of the last brake tooth of the brake bar, pushes the brake bar to move toward the preceding tumblers through the inclined plane, such that the brake end of the brake bar disengages from the brake groove on the bottom end of the lock tube, thereby achieving the secondary unlocking through linkage;
d. Along with the movement of the brake bar toward the preceding tumblers, at the same time, the preceding brake teeth of the brake bar mesh with the tooth grooves of the preceding tumblers;

The locking steps are as follows:
a. In the process of pulling the key, the key is first disengaged from the keyhole of the last tumbler, and the top end of the last tumbler enters the lock tube groove by means of a spring and returns to the locking position, thereby achieving the primary locking without linkage;
b. In the process of pulling the key, the key's back-pressure ramp drives one or several preceding tumblers thereof to move downward. While the preceding tumblers move downward, the upper inclined plane of the tooth groove on the preceding tumbler acts like a lug of a moving cam, the lug of said moving cam presses the preceding brake tooth of the brake bar, pushes the brake bar to move longitudinally toward the bottom end of the lock tube, such that the brake end of the brake bar engages with the brake groove on the bottom end of the lock tube, thereby achieving the secondary locking through linkage;
c. When the key is completely pulled out, the top end of the preceding tumbler enters the lock tube groove by means of a spring and achieves the primary locking without linkage together with the last tumbler;
d. When the brake bar enters the position of the brake groove, the lobe of the last brake tooth of the brake bar meshes with the tooth groove on the last tumbler.

The technical unlocking without a key is analyzed as follows:
1. Pick and press the preceding tumblers: friction must be used to make each preceding tumbler to enter the unlocking position. The friction between the preceding tumblers and the lock core is generated by the force transferred from the turning corners of the lock core to the preceding tumblers. As locked by the engagement between the brake end of the brake bar and the brake groove, the lock core cannot rotate. As a result, there is no friction between the lock core and the preceding tumblers, the preceding tumblers are picked and pressed, but in the end, each tumbler still returns to the locking state by means of the spring.
2. Pick and press the last tumbler such that the brake bar moves toward the preceding tumblers and the preceding brake teeth on the brake bar enter the tooth grooves of the preceding tumblers. Although the last tumbler is unlocked at this moment, the preceding tumblers are locked by the preceding brake teeth.
3. If the control of the last tumbler is released at this moment, the last tumbler returns to the locking position by means of the spring. If the preceding tumblers are picked and pressed again, the brake end of the brake bar returns to the position of the brake groove and the lock core still cannot rotate.
4. If the control of the last tumbler is not released while picking and pressing the preceding tumblers again, the brake bar is blocked by the last tumbler at this moment due to the engagement between the preceding brake teeth and the tooth grooves on the preceding tumblers. Therefore, it is impossible to pick and press the preceding tumblers to move longitudinally and the preceding tumblers are still in the locking position.

The present invention provides an anti-theft lock head with linkage unlocking and locking. Inside the lock head, the mutual brake of tumblers, brake bar and lock tube according to the prior art is retained. Moreover, there is a linkage among the brake bar, tumblers and key. The secondary unlocking and secondary locking achieved through such a linkage makes it impossible for technical unlocking to attend to everything at one time and effectively improves the lock head's anti-theft performance. According to value engineering, it also avoids the design of extra functions such that the structure is effectively simplified.

(2) The front tumblers are the following tumblers and the rear tumbler is the first tumbler. It can be described in detail that it comprises a lock tube, said lock tube comprising: axial grooves that are longitudinally symmetric, a circumferential groove, and a brake groove on the front end of the lock tube; a lock core with clearance fit provided between its outside diameter and the lock tube's corresponding inside diameter, said lock core comprising: a group of tumbler holes are distributed intervally and axially, a brake bar sliding groove formed axially and a through keyhole on the lock core; a brake bar forming clearance fit with said brake bar sliding groove, said brake bar comprising: a group of following brake teeth distributed intervally and longitudinally thereon and a first brake tooth, a boss is formed on the rear end of said brake bar, which forms clearance fit with said circumferential groove, and the brake end forms clearance fit with said brake groove at the front end of the brake bar; a group of following tumblers having clearance fits with the tumbler holes and having clearance fits with said axial grooves, said following tumblers comprising: tumbler keyholes formed on the center thereof, and at least one tooth groove is formed on each following tumbler; a first tumbler having clearance fit with the tumbler holes and having clearance fit with said axial grooves, said first tumbler comprising: a tumbler keyhole formed on the center thereof, and at least one tooth groove is formed on the first tumbler; a key that matches with the keyholes on the following tumblers and the keyhole on the first tumbler, said key comprising key teeth, the key teeth are formed by transition platforms, a pushing ramp and a back-pressure ramp, and transition connection is formed between the transition platform and the pushing ramp and the back-pressure ramp;

The symmetric surfaces of the brake bar sliding groove on the lock core intersect with the vertically symmetric surfaces of the lock core, and the symmetric surfaces of the brake bar sliding groove are located at the center of the tumbler hole height, the brake bar sliding groove on the lock core is open to the tumbler holes of the lock core;

The tooth grooves on the following tumblers are formed in the vertical center of the front planes of the following tumblers, said tooth grooves of the following tumblers have a right-angled triangle shape formed by the upper inclined plane and the bottom plane; the front planes of the following tumblers are perpendicular to the symmetric surfaces of the lock core, the openings of the tooth grooves of the following tumblers are configured to be in the same direction as the key insertion direction, the upper inclined planes and the bottom planes of the following brake teeth of the brake bar form an angle, and the following brake teeth on the rear portion of the brake bar engage with the tooth grooves of the following tumblers;

The tooth groove on the first tumbler is formed in the vertical center of the rear plane of the first tumbler, said tooth groove of the first tumbler has an angle formed by the upper inclined plane and the lower inclined plane, the back plane of the first tumbler is perpendicular to the symmetric surfaces of the lock core, the opening of the tooth groove of the first tumbler is configured to be in the reverse direction as the key insertion direction, a lobe is formed on the first brake tooth on said brake bar by the upper inclined plane and the lower inclined plane, and the first brake tooth engages with the tooth groove of the first tumbler.

The tooth groove of the above first tumbler has a shape of isosceles triangle, its upper inclined plane and lower inclined plane are symmetrical according to the angular bisector; said angular bisector of the upper inclined plane and the lower inclined plane is parallel to or on the same plane with the bottom planes of the tooth grooves of the following tumblers.

The angle between the upper inclined plane of the above tooth groove of the following tumbler and the bottom plane of the tooth groove is 43°˜60°, the angle formed by the upper inclined plane of the following brake tooth and the bottom plane of the following brake tooth is 30°˜60°, and the bottom plane of the brake tooth is parallel to the bottom planes of the tooth grooves of the following tumblers; the tooth groove of said first tumbler has a shape of isosceles triangle, the angles formed by its upper and lower inclined planes and the angular bisector are 43°˜60°; the first brake tooth of said brake bar is toward the direction of the first tumbler, and the angles between the upper and lower inclined planes of the first brake tooth that form the lobe and the angular bisector are 30°˜60°.

The angle between the upper inclined plane of the above tooth groove of the following tumbler and the bottom plane of the tooth groove is 45°, and the angle formed by the upper inclined plane and the bottom plane of said following brake tooth of the brake bar is 45°; the tooth groove of said first tumbler has a shape of isosceles triangle, and the angles formed by its upper and lower inclined planes and the angular bisector are 45°; the first brake tooth of said brake bar is toward the direction of the first tumbler, and the angles between the upper and lower inclined planes of the first brake tooth and the angular bisector are 45° .

The angle between the pushing ramp at the front end of the key and the key insertion direction is smaller than or equal to 45°.

Each of the above following tumblers is provided with at least 2 tooth grooves that are uniformly arranged in parallel from up down, and the tooth grooves have the same direction, size and angle; in the unlocking state, the bottom plane of one of the tooth grooves on each following tumbler is on the same plane as the bottom plane of the following brake tooth of the brake bar.

All transition platforms of the above key are parallel to each other and parallel to the axis of the lock core.

Given such a technical embodiment, steps to unlock and lock the linkage anti-theft lock head are, respectively:

The unlocking steps are as follows:
a. The process to unlock the following tumblers: the key is pushed forward. When the pushing ramp on the front end of the key props against the pressing surface of the keyhole on the first tumbler, all pressing surfaces of keyholes on the following tumblers are in the unlocking state of being pressed by transition platforms of the key, thereby achieving the primary unlocking of the following tumblers without linkage;
b. The process to unlock the first tumbler: the key is further pushed forward, and the pushing ramp on the front end of the key completes the process from propping against the pressing surface of the keyhole on the first tumbler to the complete pressing of the pressing surface of the keyhole on the first tumbler by a transition platform, such that the first tumbler moves downward and unlocks;
c. The process to unlock the brake bar: through the longitudinal movement of the first tumbler, at the same time, the upper inclined plane of the tooth groove on the first tumbler acts like a lug of a moving cam, the lug of said moving cam presses downwardly the upper inclined plane of the lobe of the first brake tooth of the brake bar, pushes the brake bar to move toward the following tumblers through the inclined plane, such that the brake end of the brake bar disengages from the brake groove on the bottom end of the lock tube, thereby achieving the secondary unlocking through linkage;
d. Along with the movement of the brake bar toward the following tumblers, at the same time, the following brake teeth of the brake bar mesh with the tooth grooves of the following tumblers;

The locking steps are as follows:
a. In the process of pulling the key, the key is first disengaged from the keyhole of the first tumbler, and the top end of the first tumbler enters the axial groove on the lock tube by means of a spring and returns to the locking position, thereby achieving the primary locking without linkage;
b. In the process of pulling the key, the key's back-pressure ramp drives one or several following tumblers thereof to move downward. While the following tumblers move downward, the upper inclined plane of the tooth groove on the following tumbler acts like a lug of a moving cam, the lug of said moving cam presses the following brake tooth of the brake bar, pushes the brake bar to move longitudinally toward the front end of the lock tube, such that the brake end of the brake bar engages with the brake groove on the front end of the lock tube, thereby achieving the secondary locking through linkage;
c. When the key is completely pulled out, the top end of the following tumbler enters the axial groove by means of a spring and achieves the primary locking without linkage together with the first tumbler;
d. When the brake bar enters the position of the brake groove, the lobe of the first brake tooth of the brake bar meshes with the tooth groove on the first tumbler.

The technical unlocking without a key is analyzed as follows:
1. Pick and press the preceding tumblers: friction must be used to make each following tumbler to enter the unlocking position. The friction between the following tumblers and the lock core is generated by the force transferred from the turning corners of the lock core to the following tumblers. As locked by the engagement between the brake end of the brake bar and the brake groove, the lock core cannot rotate. As a result, there is no friction between the lock core and the following tumblers, the following tumblers are picked and pressed, but in the end, each tumbler still returns to the locking state by means of the spring.
2. Pick and press the first tumbler such that the brake bar moves toward the following tumblers and the following brake teeth on the brake bar enter the tooth grooves of the following tumblers. Although the first tumbler is unlocked at this moment, the following tumblers are locked by the following brake teeth.
3. If the control of the first tumbler is released at this moment, the first tumbler returns to the locking position by means of the spring. If the following tumblers are then picked and pressed again, the brake end of the brake bar returns to the position of the brake groove and the lock core still cannot rotate.
4. If the control of the first tumbler is not released while picking and pressing the following tumblers again, the brake bar is blocked by the first tumbler at this moment due to the engagement between the following brake teeth and the tooth grooves on the following tumblers. Therefore, it is impossible to pick and press the following tumblers to move longitudinally and the following tumblers are still in the locking position.

The present invention provides an anti-theft lock head with side linkage. Inside the lock head, the mutual brake of tumblers, brake bar and lock tube according to the prior art is retained. Moreover, there is a linkage among the brake bar, tumblers and key. The secondary unlocking and secondary locking achieved through such a linkage makes it impossible for technical unlocking to attend to everything at one time and effectively improves the lock head's anti-theft performance. According to value engineering, it also avoids the design of extra functions, such as double brake bars, such that the structure is effectively simplified; at the same time, special attention is paid to the structural compatibility with existing processing techniques. By using the side installation of the brake bar for a side linkage of the brake bar with the following tumblers and the first tumbler, the following tumblers and the first tumbler effectively avoid the prior art arrangement of simultaneous engagement with the brake bar and the tumbler holes, which not only decreases the processing difficulty of the lock core, but also effectively decreases the processing difficulty of the brake bar, the following tumblers and the first tumbler.

### BRIEF DESCRIPTION OF THE DRAWINGS

FIG. 1 illustrates the assembly of the primary unlocking without linkage in Example 1 of the present invention.

FIG. 2 is a sectional view along B-B in FIG. 1.

FIG. 3 illustrates the assembly of the secondary unlocking with linkage in Example 1 of the present invention.

FIG. 4 is the full sectional front view of the lock core in Example 1 of the present invention.

FIG. 5 is a sectional view along A-A in FIG. 4.

FIG. 6 is the top view of the lock core in Example 1 of the present invention.

FIG. 7 is the full sectional front view of the brake bar in Example 1 of the present invention.

FIG. 8 is the top view of the brake bar in Example 1 of the present invention.

FIG. 9 is a sectional view along D-D in FIG. 8.

FIG. 10 is a sectional view along C-C in FIG. 8.

FIG. 11 is the front view of the preceding tumbler in Example 1 of the present invention.

FIG. 12 is the top view of the preceding tumbler in Example 1 of the present invention.

FIG. 13 is the left sectional view of the preceding tumbler in Example 1 of the present invention.

FIG. 14 is the sectional view of the last tumbler in Example 1 of the present invention.

FIG. 15 is the front sectional view of the lock tube in Example 1 of the present invention.

FIG. 16 is a sectional view along E-E in FIG. 15.

FIG. 17 is the front view of the key in Example 1 of the present invention.

FIG. 18 illustrates the assembly of the primary unlocking without linkage in Example 2 of the present invention.

FIG. 19 is a sectional view along A-A in FIG. 18.

FIG. 20 illustrates the assembly of the secondary unlocking with linkage in Example 2 of the present invention.

FIG. 21 is the partial sectional view of the lock core in Example 2 of the present invention.

FIG. 22 is a sectional view along C-C in FIG. 21.

FIG. 23 is a sectional view along D-D in FIG. 21.

FIG. 24 is the front view of the following tumbler in Example 2 of the present invention.

FIG. 25 is the left view of the following tumbler in Example 2 of the present invention.

FIG. 26 is the front view of the first tumbler in Example 2 of the present invention.

FIG. 27 is the left view of the first tumbler in Example 2 of the present invention.

FIG. 28 is the front view of the brake bar in Example 2 of the present invention.

FIG. 29 is a sectional view along B-B in FIG. 28.

FIG. 30 is the top view of the brake bar in Example 2 of the present invention.

FIG. 31 is the 3D view of the brake bar in Example 2 of the present invention.

FIG. 32 is the top view of the assembly of the primary unlocking without linkage in FIG. 18.

FIG. 33 is the top view of the assembly of the secondary unlocking with linkage in FIG. 20.

FIG. 34 is the front view of the key in Example 2 of the present invention.

1 key 2 lock core 3 end cover 4 circumferential groove 5 boss 6 preceding tumbler

7 preceding brake tooth 8 last brake tooth 9 last tumbler 10 brake groove

11 retainer ring groove 12 lock core linkage end 13 coupling cylinder 14 pressing surface

15 lock core shaft shoulder 16 lock tube 17 lock tube groove 18 lock core groove

19 brake bar 20 spring 21 spring limiting seat 22 keyhole

23 open retainer ring 24 partition plate 25 spring hole 26 tumbler hole

27 keyhole on partition plate 28 coupling hole 29 keyhole on the front end of the lock core 30 spring seat

31 upper inclined plane of the last brake tooth 32 brake end 33 lower inclined plane of the last brake tooth

34 upper inclined plane of the tooth groove of the preceding tumbler 35 bottom plane of the tooth groove of the preceding tumbler

36 pressing surface 37 upper inclined plane of the tooth groove of the last tumbler 38 lower inclined plane of the tooth groove of the last tumbler

39 transition platform 40 transition platform 41 pushing ramp 42 pushing ramp 43 back-pressure ramp

101 key 102 end cover 103 lock core 104 lock tube 105 following tumbler

106 partition plate 107 axial groove 108 first tumbler 109 lock core linkage end

110 front shaft shoulder 111 rear shaft shoulder 112 axial groove 113 circumferential groove

114 symmetrical surfaces of the brake bar sliding groove 115 symmetrical surfaces of the lock core 116 spring pressing seat

117 spring 118 spring hole 119 spring base 120 tumbler keyhole

121 tooth groove of the first tumbler 122 upper inclined plane of the tooth groove of the first tumbler

123 lower inclined plane of the tooth groove of the first tumbler 124 tooth groove of the following tumbler

125 bottom plane of the tooth groove of the following tumbler 126 upper inclined plane of the tooth groove of the following tumbler

127 brake bar 128 boss of the brake bar 129 following brake tooth 130 first brake tooth 131 brake end 132 lower inclined plane of the first brake tooth 133 upper inclined plane of the first brake tooth

134 upper inclined plane of the following brake tooth 135 bottom plane of the following brake tooth 136 brake bar sliding groove 137 tumbler hole 138 lock core keyhole 139 brake groove 140 transition platform

141 pushing ramp 142 pushing ramp 143 back-pressure ramp

### DETAILED DESCRIPTION OF THE PREFERRED EXAMPLES

### Example 1

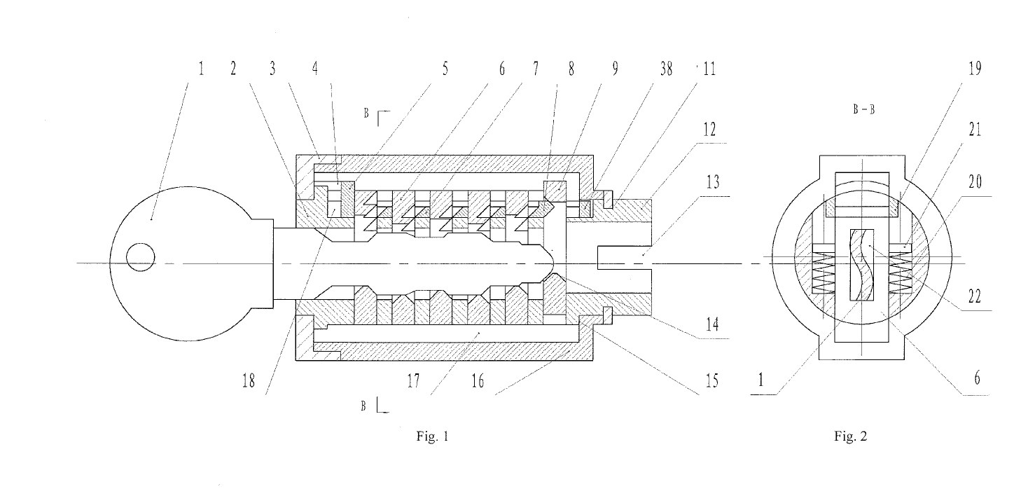

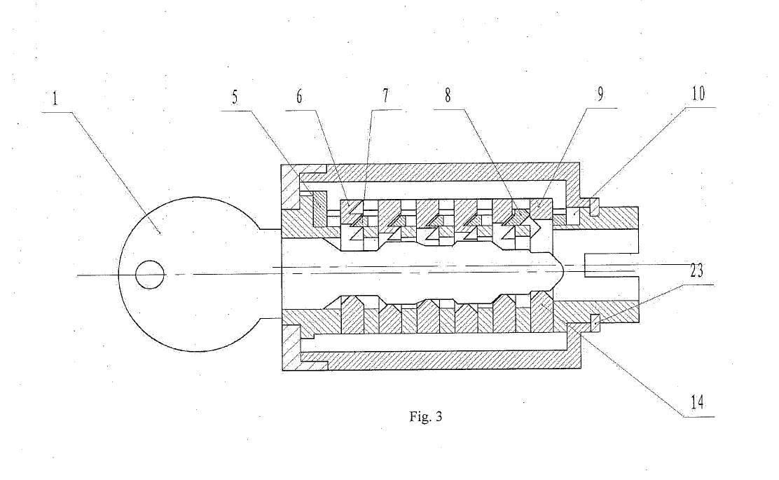

For said anti-theft lock head with linkage unlocking and locking shown in FIG. 1, FIG. 2 and FIG. 3, the front end of the lock tube 16 is fitted with an end cover 3, and clearance fit is provided between the end cover 3 and the front end of the lock core 2. A lock core groove 18 is provided axially on the top portion of the lock core for clearance fit with the brake bar 19. The end of the lock core 2 is provided with a lock core linkage end 12. The lock core linkage end 12 is provided with a coupling cylinder 13 for engagement with the linkage device of the lock body. The lock core is axially positioned through a lock core shaft shoulder 15 and an open retainer ring 23 on the retainer ring groove 11 at the end of the lock core. All tumblers in front of the last tumbler 9 are referred to as preceding tumblers 6. The preceding tumblers 6 and the last tumbler 9 are installed in the tumbler holes 26 distributed intervally and axially on the lock core. Clearance fits are provided between the preceding tumblers 6 and the last tumbler 9 and the tumbler holes 26 of the lock core. The key 1 engages with the keyholes 27 on partition plates of the lock core, keyholes on the preceding tumblers and the keyhole 22 on the last tumbler. A boss 5 is formed on the front end of said brake bar, which engages with the circumferential groove 4 or the lock tube groove 17 on the front end of the lock tube. A brake end 32 is formed on the end of the brake bar, which engages with the brake groove 10 at the bottom end of the lock tube. The brake bar is provided with preceding brake teeth 7 for meshing with the tooth grooves of the preceding tumblers and a last brake tooth 8 for meshing with the tooth groove of the last tumbler. FIG. 1 illustrates a state in which the front end of the key 1 contacts the pressing surface 14 of the last tumbler 9 but has not pressed against it yet. FIG. 3 illustrates the pressing state between the front end of the key 1 and the pressing surface 14 of the last tumbler 9.

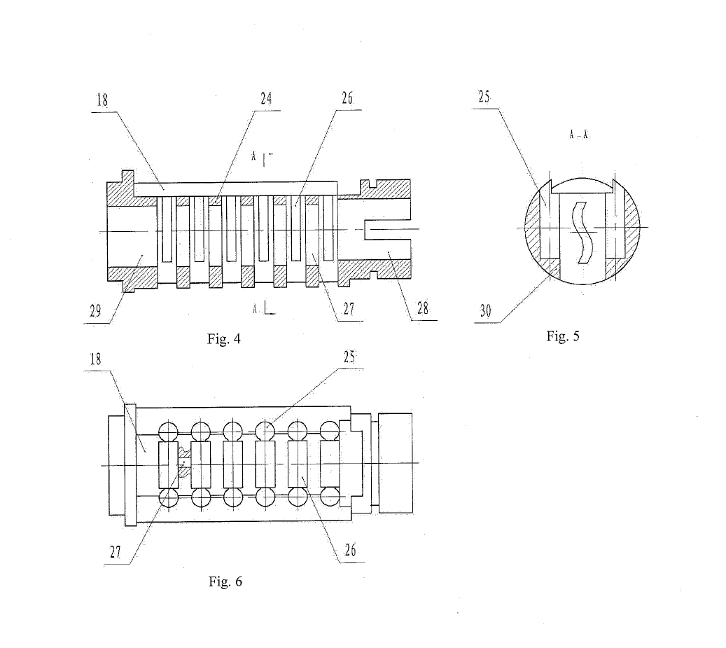

As shown in FIG. 4, FIG. 5 and FIG. 6, an open-mouth shaped cylindrical lock core groove 18 is formed on the top of the lock core, the lock core groove is disposed along the axis of the lock core, tumbler holes 26 are distributed intervally and longitudinally on the bottom plane of the lock core groove, and the tumbler holes are perpendicular to the bottom plane of the lock core. Partition plates 24 are disposed between the tumbler holes, and keyholes 27 are formed on the partition plates 24. The keyholes 27 are on the same axis as the keyhole 29 on the front end of the lock core. The coupling hole 28 and the coupling cylinder 13 formed on the lock core linkage end 12 are reserved for linkage with the lock body, the structure of which varies on different lock types. Spring holes 25 are formed symmetrically on two sides of each tumbler hole 26 and open thereto, and a spring seat 30 is disposed underneath the spring holes.

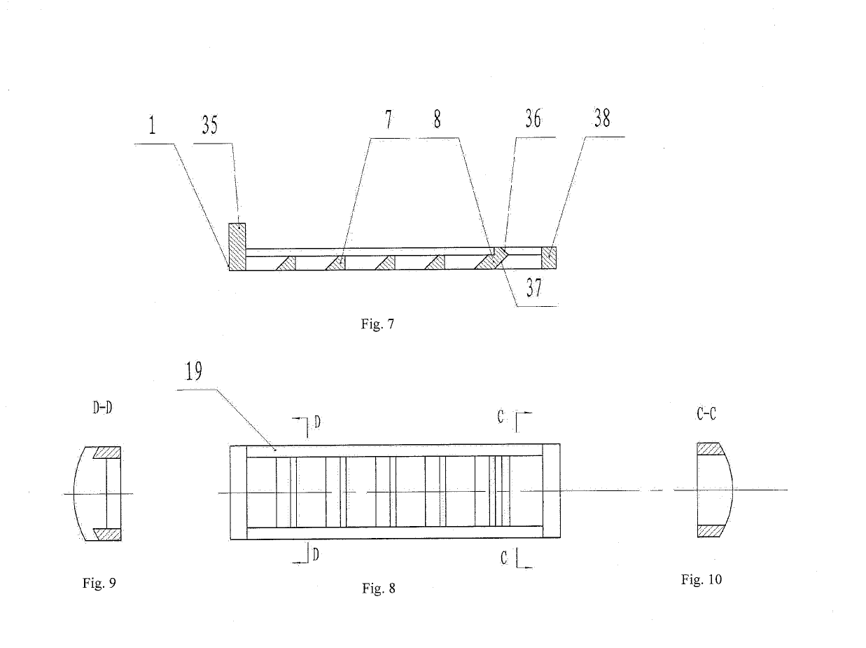

As shown in FIG. 7, FIG. 8, FIG. 9 and FIG. 10, preceding brake teeth 7 are distributed intervally and longitudinally on the brake bar 19 for meshing with the tooth grooves of corresponding preceding tumblers, the horizontal width of the preceding brake teeth 7 is greater than the horizontal width of the preceding tumblers and the last tumbler, and the upper inclined plane of the preceding brake tooth forms an angle of 30°˜60° with the bottom plane of the brake bar, preferably 45°. The bottom plane of the brake bar is parallel to the bottom plane of the tooth grooves. A last brake tooth 8 is formed on the brake bar. The angle between the upper inclined plane and the bottom plane of the end of said last brake tooth of the brake bar facing the preceding tumbler is 30°˜60°, preferably 45°. At the end of said last brake tooth of the brake bar facing the last tumbler, the upper inclined plane 31 and the lower inclined plane 33 form a lobe, the angles between the upper inclined plane 31 and the lower inclined plane 33 and the angular bisector are 30°˜60°, preferably 45°. A brake end 32 is formed on the end of the brake bar for engaging with the brake groove at the bottom end of the lock tube. A boss 5 is formed on the front end of said brake bar for engaging with the lock tube groove and the circumferential groove of the lock tube.

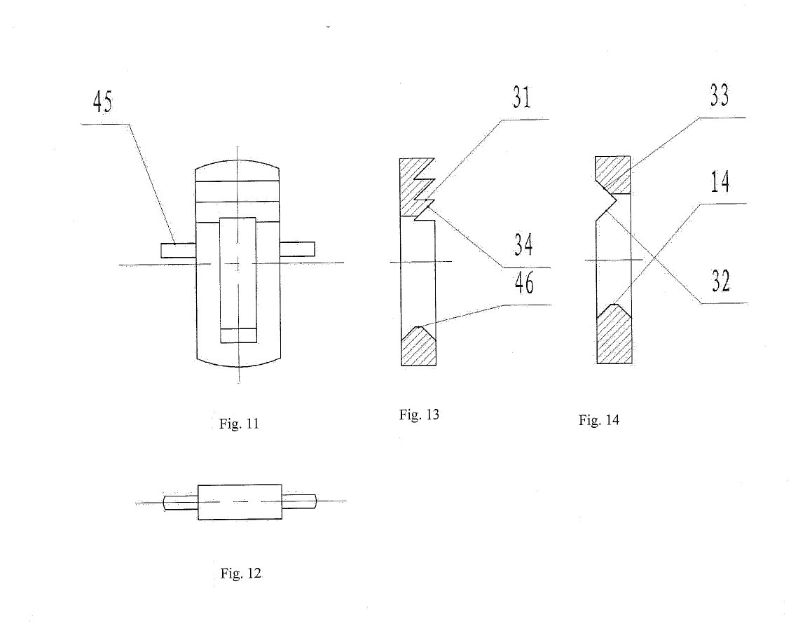

As shown in FIG. 11, FIG. 12, FIG. 13 and FIG. 14, at least one tooth groove is formed on the front or the back of each preceding tumbler. On the preceding tumbler, the upper inclined plane 34 of the tooth groove intersects with the bottom plane 35 of the tooth groove to form a right-angled triangle, and the opening of the tooth groove of the preceding tumbler is in the same direction as the key insertion direction. The angle between the upper inclined plane of said tooth groove of the preceding tumbler and the bottom plane of the tooth groove is 43°˜60°, preferably 45°. The bottom plane of the tooth groove is parallel to the bottom plane of the brake bar. At least one tooth groove is formed on the front or the back of the last tumbler, said tooth groove of the last tumbler has a shape of isosceles triangle, its upper and lower inclined planes 37 and 38 form an isosceles triangle, and the angles formed by its upper and lower inclined planes and the angular bisector are 43°˜60°, preferably 45°. The angular bisector of the upper and lower inclined planes is parallel to the bottom plane of the brake bar. The opening of the tooth groove of the last tumbler is in the reverse direction as the key insertion direction. Keyholes are formed on the center of the preceding tumblers and the last tumbler, and the cross sections of the pressing surfaces 36 and 14 of the bottom of the key holes are chamfered or curved for easy pulling of a key. Spring limiting seats 21 are formed symmetrically on both sides of the tumblers, which limit the springs inside the spring holes together with the spring seats of the lock core. To provide a relatively large space for vertical displacement of the preceding tumblers and the following tumblers inside the lock tube, the upper and lower curved surfaces of the preceding tumblers and the following tumblers may be processed to be flat so as to appropriately shorten their longitudinally heights.

Each of said preceding tumblers is provided with at least 2 tooth grooves that are uniformly arranged in parallel from up down, and the tooth grooves have the same direction, size and angle; in the unlocking state, the bottom plane of one of the tooth grooves on each preceding tumbler is on the same plane as the bottom plane of the preceding brake tooth of the brake bar.

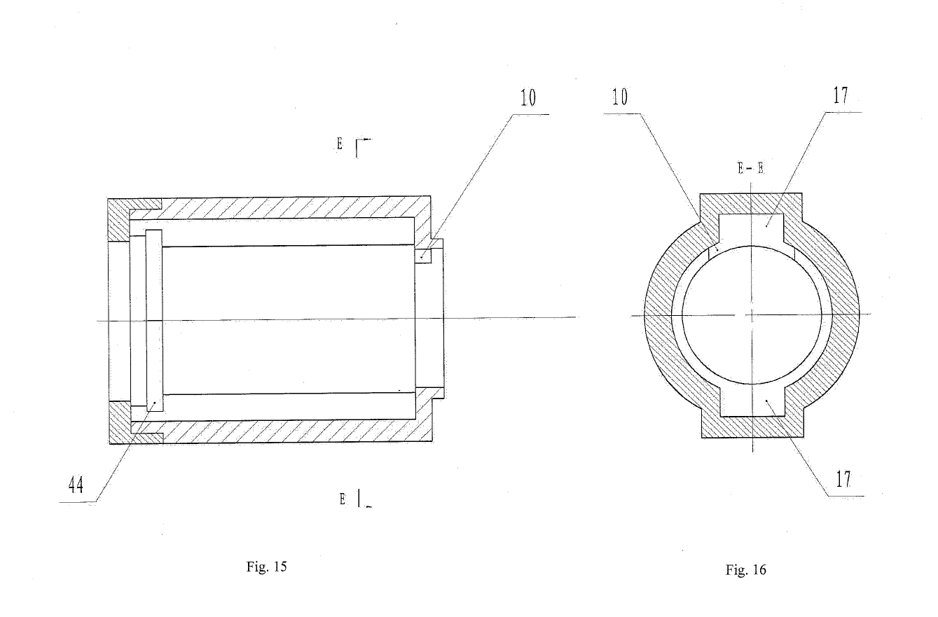

As shown in FIG. 15 and FIG. 16, a brake end 32 is formed on the last position of said brake bar, which engages with the brake groove 10 at the bottom end of the lock tube. The lock core groove 17 is used to limit the preceding tumblers and the following tumblers. When it engages with the preceding tumblers and the following tumblers, the lock core is locked and cannot rotate. A circumferential groove 4 is formed on the front end of the lock tube for engaging with the boss 5 of the brake bar. When the brake end of the brake bar disengages from the brake groove, the front end of the brake bar enters the circumferential groove from the lock tube groove such that the lock core rotates.

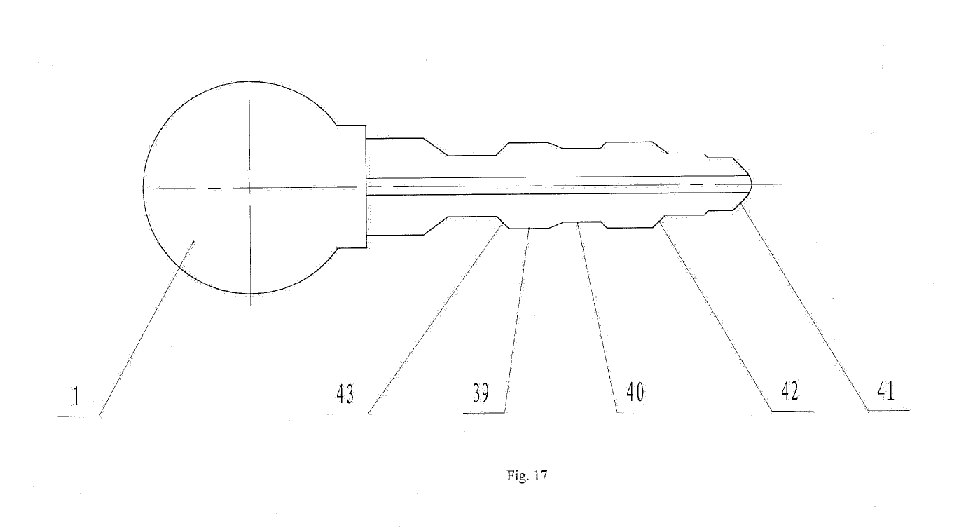

As shown in FIG. 17, said teeth of the key 1 are formed by transition platforms 39 and 40, a pushing ramp 42 and a back-pressure ramp 43, and transition connection is formed between the transition platforms and the pushing ramp and the back-pressure ramp; the longitudinally advancing length of any transition platform needs to satisfy the contour advancing length of other transition platforms in the advancing process to prop against the pressing surface of the keyhole on the tumbler; the entire key has at least one back-pressure ramp and the height of the back-pressure ramp equals the height of the preceding brake tooth or the sum of the heights of progressive back-pressure ramps; the front end of the key is provided with a pushing ramp 41; the key is coded according to the heights of transition platforms. The front end of the key is the pushing ramp 41 smaller than or equal to 45°. All transition platforms of said key are parallel to each other and parallel to the axis of the lock core.

As shown in FIG. 1, FIG. 3 and FIG. 17.

Its unlocking and locking steps are, respectively:

The unlocking steps are as follows:
a. The process to unlock the preceding tumblers: the key 1 is pushed forward. When the pushing ramp 41 on the front end of the key props against the pressing surface 14 of the keyhole on the last tumbler, all pressing surfaces of keyholes on the preceding tumblers 6 are in the unlocking state of being pressed by transition platforms 39 and 40 of the key 1, thereby achieving the primary unlocking of the preceding tumblers 6 without linkage;
b. The process to unlock the last tumbler: the key 1 is further pushed forward, and the pushing ramp 41 on the front end of the key completes the process from propping against the pressing surface 14 of the keyhole on the last tumbler to the complete pressing of the pressing surface 14 of the keyhole on the last tumbler 9 by a transition platform, such that the last tumbler moves downward and unlocks;
c. The process to unlock the brake bar: through the movement of the last tumbler 9, at the same time, the upper inclined plane of the tooth groove on the last tumbler presses downwardly the upper inclined plane of the lobe of the last brake tooth 8 of the brake bar, pushes the brake bar to move toward the preceding tumblers 6 through the inclined plane, such that the brake end 32 of the brake bar disengages from the brake groove 10 on the bottom end of the lock tube, thereby achieving the secondary unlocking through linkage;
d. Along with the movement of the brake bar toward the preceding tumblers 6, at the same time, the preceding brake teeth 7 of the brake bar mesh with the tooth grooves of the preceding tumblers;

The locking steps are as follows:
a. In the process of pulling the key 1, the key is first disengaged from the keyhole of the last tumbler 9, and the top end of the last tumbler enters the lock tube groove 17 by means of a spring and returns to the locking position, thereby achieving the primary locking without linkage;
b. In the process of pulling the key 1, the key's back-pressure ramp 43 drives one or several preceding tumblers thereof to move downward. While the preceding tumblers 6 move downward, the upper inclined plane of the tooth groove on the preceding tumbler presses the preceding brake tooth 7 of the brake bar, pushes the brake bar to move longitudinally toward the bottom end of the lock tube, such that the brake end 32 of the brake bar engages with the brake groove 10 on the bottom end of the lock tube, thereby achieving the secondary locking through linkage;
c. When the key is completely pulled out, the top end of the preceding tumbler 6 enters the lock tube groove 17 by means of a spring and achieves the primary locking without linkage together with the last tumbler;
d. When the brake bar enters the position of the brake groove, the lobe of the last brake tooth of the brake bar meshes with the tooth groove on the last tumbler.

### Example 2

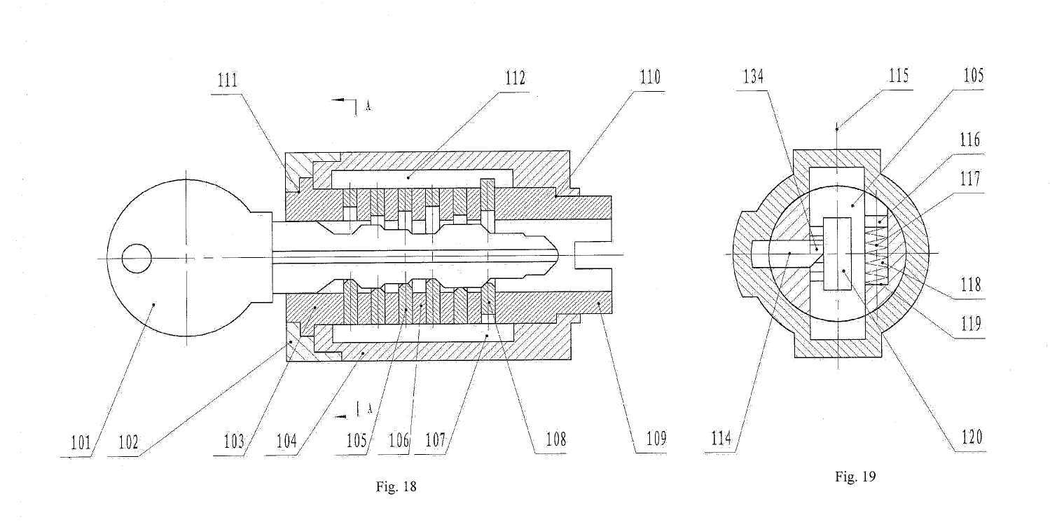

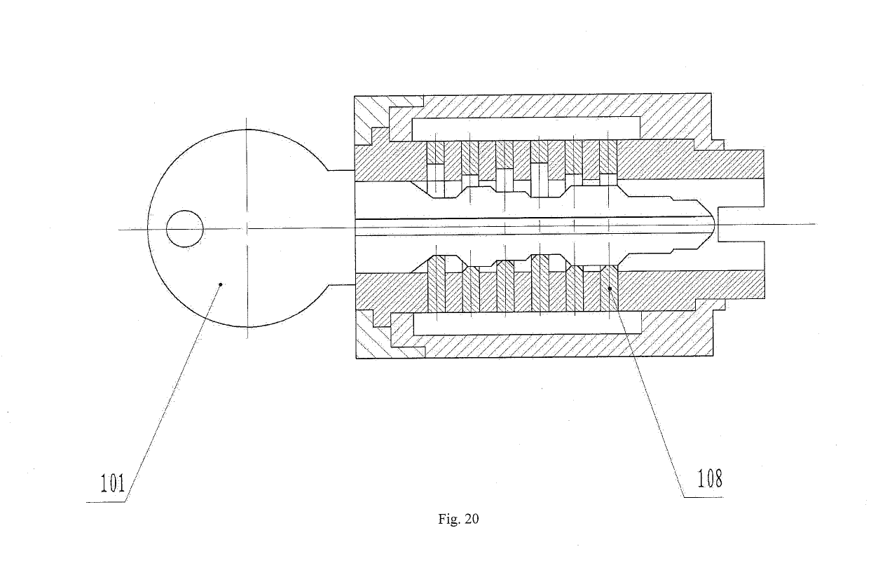

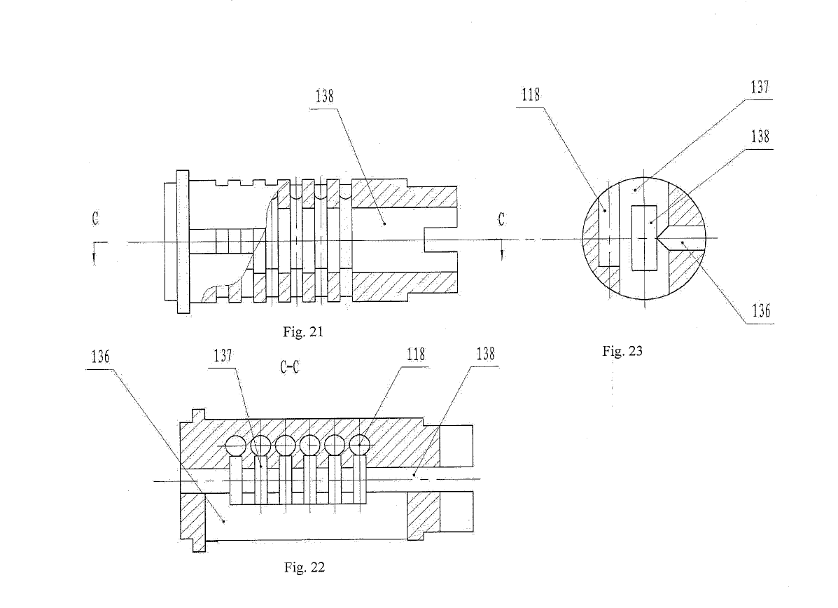

As shown in FIG. 18, FIG. 19, FIG. 20, FIG. 21, FIG. 22 and FIG. 23, an anti-theft lock head with side linkage comprises a lock tube 104, said lock tube comprising: axial grooves 107 and 112 that are longitudinally symmetric, a circumferential groove, and a brake groove on the front end of the lock tube; an end cover 102 fitted on the rear end of the lock tube; a lock core 103 with clearance fit provided between its outside diameter and the lock tube's corresponding inside diameter, said lock core comprising: a group of tumbler holes 137 are distributed intervally and axially, partition plates 106 between the tumbler holes, a brake bar sliding groove 136 formed axially and a through keyhole 138 on the lock core, said lock core keyhole engages with the key 101, a spring hole 118 is formed on the same side of each tumbler hole that is open longitudinally thereto, and a spring base 119 is disposed underneath the spring hole; the front end of the lock core is provided with a lock core linkage end 109; the lock core engages with the lock tube 104 and the end cover 102 through a front shaft shoulder 110 and a rear shaft shoulder 111 to limit the axial freedom of the lock core. The symmetric surfaces 114 of the brake bar sliding groove 136 on the lock core intersect with the vertical lock core symmetric surfaces 115, the symmetric surfaces 114 of the brake bar sliding groove 136 are located at the center of the tumbler hole height, and the brake bar sliding groove on the lock core is open to the tumbler holes of the lock core; a first tumbler 108 has clearance fit with the tumbler hole at the foremost end (i.e. the head end), a group of following tumblers 105 have clearance fits with corresponding tumbler holes 137 and have clearance fits with said axial grooves 107 and 112; tumbler keyholes 120 are formed at the center of the first tumbler and the following tumblers; a spring 117 is placed in said each spring hole 118 to control the following tumblers and the first tumbler, and the spring is disposed between the spring base 119 and the spring pressing seat 116.

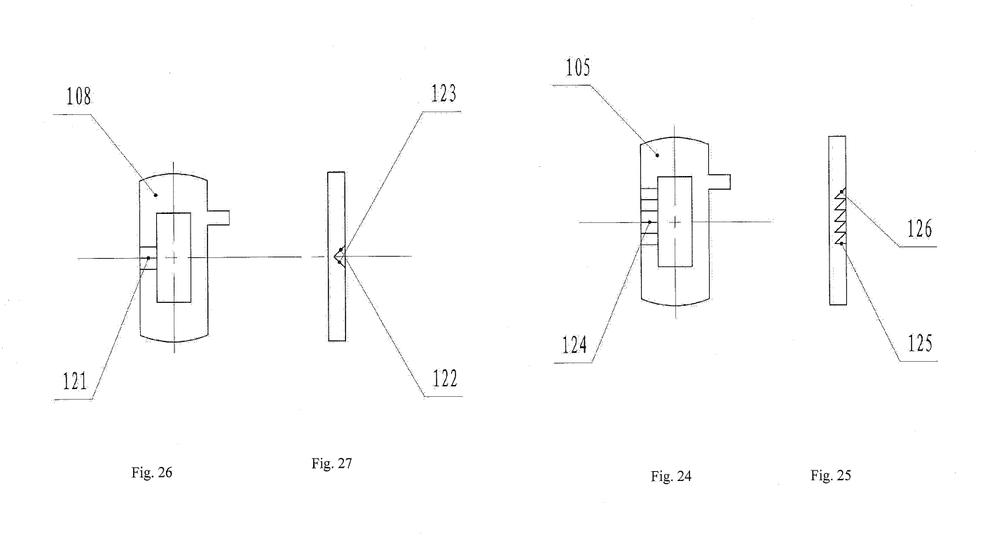

As shown in FIG. 24, FIG. 25, FIG. 26 and FIG. 27, at least one tooth groove 121 is formed on the first tumbler 108, the tooth groove 121 of the first tumbler 108 has an angle formed by the upper inclined plane 122 and the lower inclined plane 123, and has a shape of isosceles triangle, its upper and lower inclined planes have an angle of 45° with the angular bisector. Said angular bisector of the upper inclined plane and the lower inclined plane is parallel to the bottom planes of the tooth grooves of the following tumbler or on the same plane. The tooth groove 121 of the first tumbler is formed in the vertical center of the rear plane of the first tumbler, the back plane of the first tumbler is perpendicular to the symmetric surfaces 115 of the lock core, and the opening of the tooth groove of the first tumbler is configured to be in the reverse direction as the key insertion direction.

At least one tooth groove 124 is formed on each the following tumbler 105, each following tumbler is provided with at least 2 tooth grooves that are uniformly arranged in parallel from up down, and the tooth grooves have the same direction, size and angle. The tooth groove 124 of the following tumbler 105 has a right-angled triangle shape formed by the upper inclined plane 126 and the bottom plane 125, and the angle between the upper inclined plane of the tooth groove and the bottom plane is 45°; the tooth grooves on the following tumblers are formed in the vertical center of the front planes of the following tumblers. The front planes of the following tumblers are perpendicular to the symmetric surfaces 115 of the lock core, and the opening of the tooth groove of each following tumbler is configured to be in the same direction as the key insertion direction.

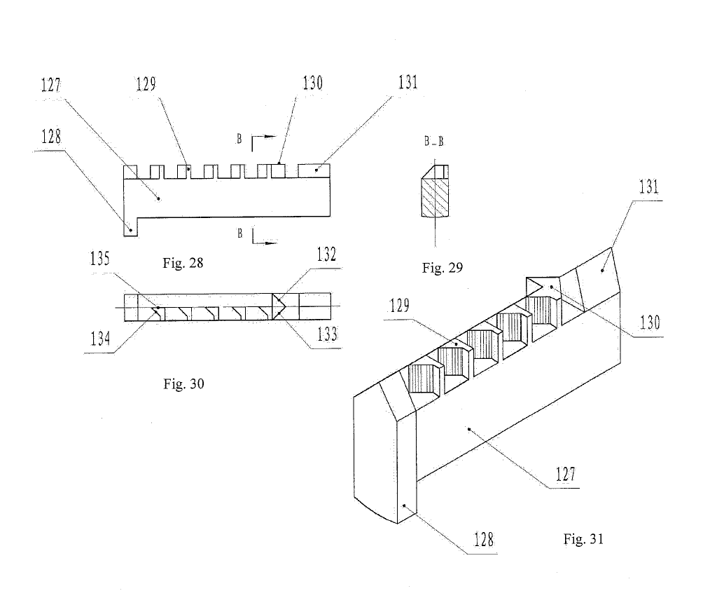

As shown in FIG. 28, FIG. 29, FIG. 30 and FIG. 31, said brake bar 127 comprises: a group of following brake teeth 129 distributed intervally and longitudinally thereon and a first brake tooth 130, a boss 128 is formed on the rear end of said brake bar, and a brake end 131 is formed on the front end of the brake bar. A lobe is formed on the first brake tooth on said brake bar by the upper inclined plane 133 and the lower inclined plane 132 for engaging with the tooth groove of the first tumbler; the first brake tooth on said brake bar faces the direction of the first tumbler. The upper inclined planes 134 and the bottom planes 135 of the following brake teeth at the rear portion of the brake bar form angles for meshing with the tooth grooves of the following tumblers. Said angles formed by the upper inclined planes and the bottom planes of the following brake teeth of the brake bar are 45°. The angles between said upper and lower inclined planes of the first brake tooth of the brake bar and the angular bisector are 45°. In the unlocking state, the bottom plane of one of the tooth grooves on each following tumbler is on the same plane as the bottom plane of the following brake tooth of the brake bar.

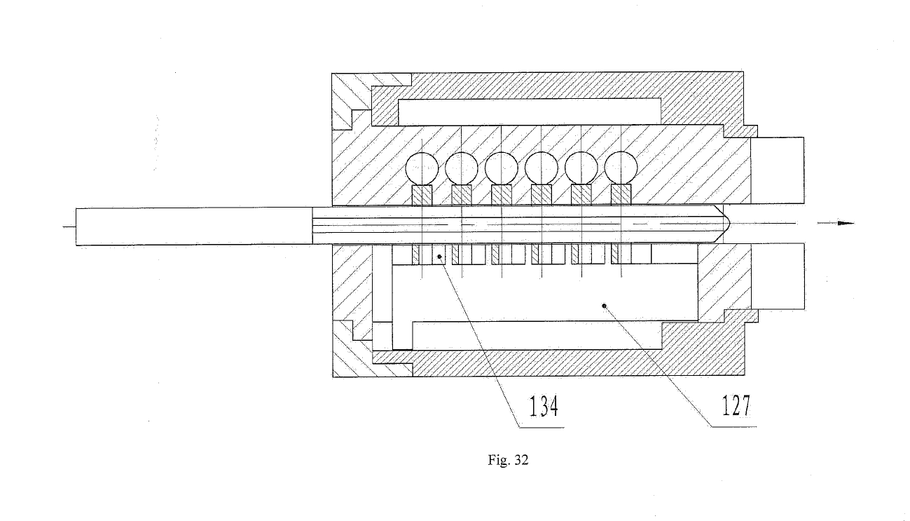

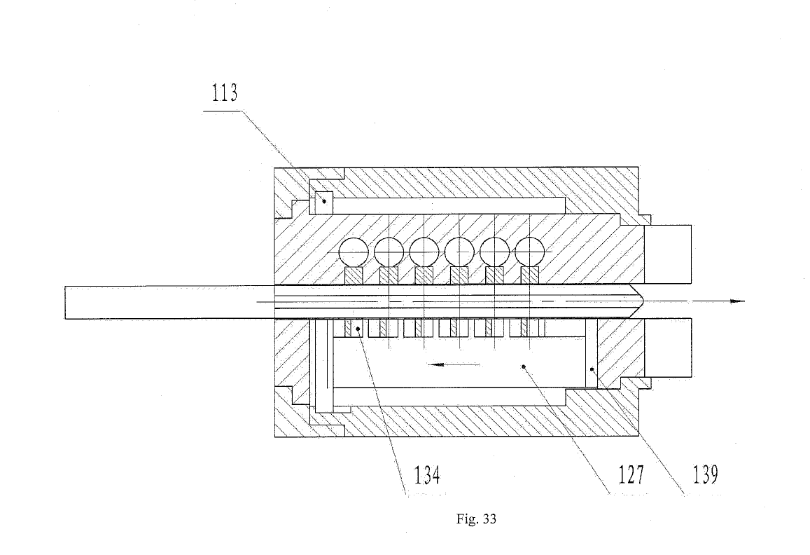

As shown in FIG. 32 and FIG. 33, clearance fit is provided between the brake bar 127 and said brake bar sliding groove, a boss 128 is formed at the rear end of the brake bar for clearance fit with said circumferential groove 113; a brake end 131 is formed at the front end of the brake bar for clearance fit with said brake groove 139.

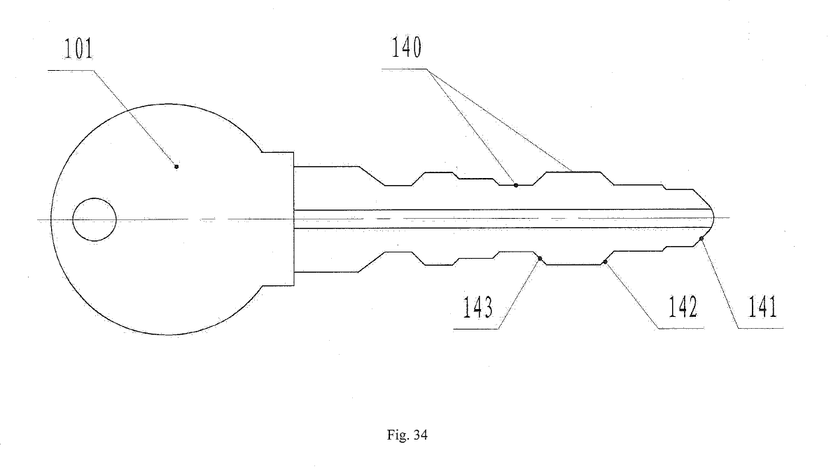

As shown in FIG. 34, a key matches with the keyholes on the following tumblers and the keyhole on the first tumbler. Said key comprises key teeth, and the key teeth are formed by transition platforms 140, pushing ramps 141 and 142, and back-pressure ramps 143. Transition connection is formed between the transition platforms 140 and the pushing ramps and the back-pressure ramps. The angle between the pushing ramp at the front end of the key and the key insertion direction is smaller than or equal to 45°. All transition platforms of said key are parallel to each other and parallel to the axis of the lock core.

As shown in FIG. 18, FIG. 32, FIG. 20 and FIG. 33, its unlocking and locking steps are, respectively:

I. The unlocking steps are as follows:
a. The process to unlock the following tumblers 105: the key 101 is pushed forward. When the pushing ramp 141 on the front end of the key props against the pressing surface of the keyhole on the first tumbler 108, all pressing surfaces of keyholes on the following tumblers are in the unlocking state of being pressed by transition platforms 140 of the key, thereby achieving the primary unlocking of the following tumblers without linkage;
b. The process to unlock the first tumbler 108: the key 101 is further pushed forward, and the pushing ramp 141 on the front end of the key completes the process from propping against the pressing surface of the keyhole on the first tumbler to the complete pressing of the pressing surface of the keyhole on the first tumbler by a transition platform, such that the first tumbler moves downward and unlocks;
c. The process to unlock the brake bar: through the longitudinal movement of the first tumbler 108, at the same time, the upper inclined plane of the tooth groove on the first tumbler presses downwardly the upper inclined plane of the first brake tooth of the brake bar, pushes the brake bar to move toward the following tumblers through the inclined plane, such that the brake end of the brake bar 127 disengages from the brake groove 139 on the bottom end of the lock tube, thereby achieving the secondary unlocking through linkage;
d. Along with the movement of the brake bar toward the following tumblers, at the same time, the following brake teeth of the brake bar mesh with the tooth grooves of the following tumblers;

The locking steps are as follows:
a. In the process of pulling the key, the key 101 is first disengaged from the keyhole of the first tumbler 108, and the top end of the first tumbler enters the axial groove on the lock tube by means of a spring and returns to the locking position, thereby achieving the primary locking without linkage;
b. In the process of pulling the key, the key's back-pressure ramp drives one or several following tumblers thereof to move downward. While the following tumblers move downward, the upper inclined plane of the tooth groove on the following tumbler presses the following brake tooth of the brake bar, pushes the brake bar to move longitudinally toward the front end of the lock tube, such that the brake end of the brake bar engages with the brake groove on the front end of the lock tube, thereby achieving the secondary locking through linkage;
c. When the key is completely pulled out, the top end of the following tumbler enters the axial groove by means of a spring and achieves the primary locking without linkage together with the first tumbler;
d. When the brake bar enters the position of the brake groove, the first brake tooth of the brake bar meshes with the tooth groove on the first tumbler.

The technical unlocking without a key is analyzed as follows:
1. Pick and press the following tumblers: friction must be used to make each following tumbler to enter the unlocking position. The friction between the following tumblers and the lock core is generated by the force transferred from the turning corners of the lock core to the following tumblers. As locked by the engagement between the brake end of the brake bar and the brake groove, the lock core cannot rotate. As a result, there is no friction between the lock core and the following tumblers, the following tumblers are picked and pressed, but in the end, each tumbler still returns to the locking state by means of the spring.
2. Pick and press the first tumbler such that the brake bar moves toward the following tumblers and the following brake teeth on the brake bar enter the tooth grooves of the following tumblers. Although the first tumbler is unlocked at this moment, the following tumblers are locked by the following brake teeth.
3. If the control of the first tumbler is released at this moment, the first tumbler returns to the locking position by means of the spring. If the following tumblers are then picked and pressed again, the brake end of the brake bar returns to the position of the brake groove and the lock core still cannot rotate.
4. If the control of the first tumbler is not released while picking and pressing the following tumblers again, the brake bar is blocked by the first tumbler at this moment due to the engagement between the following brake teeth and the tooth grooves on the following tumblers. Therefore, it is impossible to pick and press the following tumblers to move longitudinally and the following tumblers are still in the locking position.

1. A linkage anti-theft lock head, comprising a lock tube, a lock core, a brake bar, a front tumbler with its return spring, a rear tumbler with its return spring and a key. Clearance fits are provided between said front tumbler and the rear tumbler and the tumbler holes distributed axially on the lock core, said brake bar is mounted axially along the lock core thereof, brake teeth of the brake bar engage with the tooth grooves of the front tumbler and the rear tumbler, characterized in that a mobile cam device is formed with the front tumbler and the rear tumbler acting as moving cams set oppositely, the brake bar acting as a driven member and the lock core acting as a rack, the brake teeth of the tooth grooves of the front tumbler and the rear tumbler are engaged to form a linkage engagement, and a brake groove is formed on the lock tube to engage with the brake bar.

2. The linkage anti-theft lock head as set forth in claim 1, characterized in that the front tumblers are the preceding tumblers and the rear tumbler is the last tumbler. It can be described in detail that it comprises a lock tube, a lock core, a brake bar, preceding tumblers, a last tumbler and a key, a plurality of tumbler holes are distributed intervally and axially on the lock core, keyholes are formed on the center of the tumblers, clearance fits are provided between the tumblers and the tumbler holes on the lock core, a lock core groove is formed axially on the top portion of the lock core to form clearance fit with the brake bar, and a boss is formed on the front end of said brake bar for engaging with the circumferential groove on the front end of the lock tube,
All tumblers in front of the last tumbler are preceding tumblers, at least one tooth groove is formed on the front or the back of each preceding tumbler. On the preceding tumbler, the upper inclined plane of the tooth groove forms an angle with the bottom plane of the tooth groove, and the opening of the tooth groove of the preceding tumbler is in the same direction as the key insertion direction; preceding brake teeth are distributed intervally and longitudinally on the brake bar to engage with the tooth grooves on the preceding tumblers;
At least one tooth groove is formed on the front or the back of the last tumbler, on the last tumbler, the upper inclined plane of the tooth groove forms an angle with the bottom plane of the tooth groove, the opening of the tooth groove of the last tumbler is in the reverse direction as the key insertion direction, and a last brake tooth is formed on the brake bar; the shape of one end of said last brake tooth is the same as that of the preceding brake teeth and engages with the tooth groove on the neighboring preceding tumbler, while the other end thereof has a lobe formed by the upper inclined plane and the lower inclined plane for engagement with the tooth groove of the last tumbler;
A brake end is formed on the last position of said brake bar, which engages with the brake groove on the bottom end of the lock tube;
The key teeth of said key are formed by transition platforms, a pushing ramp and a back-pressure ramp, and transition connection is formed between the transition platforms and the pushing ramp and the back-pressure ramp; the longitudinally advancing length of any transition platform needs to satisfy the contour advancing length of other transition platforms in the advancing process to prop against the pressing surface of the keyhole on the tumbler; the entire key has at least one back-pressure ramp and the height of the back-pressure ramp equals the height of the preceding brake tooth or the sum of the heights of progressive back-pressure ramps; the front end of the key is provided with a pushing ramp; the key is coded according to the heights of transition platforms.

3. The linkage anti-theft lock head as set forth in claim 2, characterized in that the tooth grooves of said preceding tumblers have a right-angled triangle shape formed by the upper inclined plane and the bottom plane of the tooth groove; the horizontal width of said preceding brake tooth is greater than or equal to the horizontal width of the tumbler, and the upper inclined plane of the preceding brake tooth forms an angle with the bottom plane of the brake bar; the tooth groove of said last tumbler has a shape of isosceles triangle, its upper inclined plane and lower inclined plane are symmetrical according to the angular bisector, and said angular bisector is parallel to the bottom plane of the brake bar.

4. The linkage anti-theft lock head as set forth in claim 2, characterized in that the angle between the upper inclined plane of the above tooth groove of the preceding tumbler and the bottom plane of the tooth groove is 43°˜60°, the angle formed by the upper inclined plane of the above preceding brake tooth and the bottom plane of the brake bar is 30°˜60°, and the bottom plane of the brake bar is parallel to the bottom plane of the tooth groove;
the tooth groove of said last tumbler has a shape of isosceles triangle, the angles formed by its upper and lower inclined planes and the angular bisector are 43°˜60°; the angle between the upper inclined plane and the bottom plane of the end of said last brake tooth of the brake bar facing the preceding tumbler is 30°˜60°, and the angles between the upper and lower inclined planes of the end of said last brake tooth of the brake bar facing the last tumbler that form the lobe and the angular bisector are 30°˜60°.

5. The linkage anti-theft lock head as set forth in claim 2, characterized in that the angle between the upper inclined plane of said tooth groove of the preceding tumbler and the bottom plane of the tooth groove is 45°, and the angle formed by the upper inclined plane of the above preceding brake tooth and the bottom plane of the brake bar is 45°; the tooth groove of said last tumbler has a shape of isosceles triangle, the angles formed by its upper and lower inclined planes and the angular bisector are 45°; the angle between the upper inclined plane and the bottom plane of the end of said last brake tooth of the brake bar facing the preceding tumbler is 45° , and the angles between the upper and lower inclined planes of the end of said last brake tooth of the brake bar facing the last tumbler that form the lobe and the angular bisector are 45°.

6. The linkage anti-theft lock head as set forth in claim 2, characterized in that the front end of the key is a pushing ramp smaller than or equal to 45°.

7. The linkage anti-theft lock head as set forth in claim 2, characterized in that each of said preceding tumblers is provided with at least 2 tooth grooves that are uniformly arranged in parallel from up down, and the tooth grooves have the same direction, size and angle; in the unlocking state, the bottom plane of one of the tooth grooves on each preceding tumbler is on the same plane as the bottom plane of the preceding brake tooth of the brake bar.

8. The linkage anti-theft lock head as set forth in claim 2, characterized in that all transition platforms of said key are parallel to each other and parallel to the axis of the lock core.

9. The linkage anti-theft lock head as set forth in claim 2, characterized in that its unlocking and locking steps are, respectively:
The unlocking steps are as follows:
a. The process to unlock the preceding tumblers: the key is pushed forward. When the pushing ramp on the front end of the key props against the pressing surface of the keyhole on the last tumbler, all pressing surfaces of keyholes on the preceding tumblers are in the unlocking state of being pressed by transition platforms of the key, thereby achieving the primary unlocking of the preceding tumblers without linkage;
b. The process to unlock the last tumbler: the key is further pushed forward, and the pushing ramp on the front end of the key completes the process from propping against the pressing surface of the keyhole on the last tumbler to the complete pressing of the pressing surface of the keyhole on the last tumbler by a transition platform, such that the last tumbler moves downward and unlocks;
c. The process to unlock the brake bar: through the movement of the last tumbler, at the same time, the upper inclined plane of the tooth groove on the last tumbler presses downwardly the upper inclined plane of the lobe of the last brake tooth of the brake bar, pushes the brake bar to move toward the preceding tumblers through the inclined plane, such that the brake end of the brake bar disengages from the brake groove on the bottom end of the lock tube, thereby achieving the secondary unlocking through linkage;
d. Along with the movement of the brake bar toward the preceding tumblers, at the same time, the preceding brake teeth of the brake bar mesh with the tooth grooves of the preceding tumblers;
The locking steps are as follows:
a. In the process of pulling the key, the key is first disengaged from the keyhole of the last tumbler, and the top end of the last tumbler enters the lock tube groove by means of a spring and returns to the locking position, thereby achieving the primary locking without linkage;
b. In the process of pulling the key, the key's back-pressure ramp drives one or several preceding tumblers thereof to move downward. While the preceding tumblers move downward, the upper inclined plane of the tooth groove on the preceding tumbler presses the preceding brake tooth of the brake bar, pushes the brake bar to move longitudinally toward the bottom end of the lock tube, such that the brake end of the brake bar engages with the brake groove on the bottom end of the lock tube, thereby achieving the secondary locking through linkage;
c. When the key is completely pulled out, the top end of the preceding tumbler enters the lock tube groove by means of a spring and achieves the primary locking without linkage together with the last tumbler;
d. When the brake bar enters the position of the brake groove, the lobe of the last brake tooth of the brake bar meshes with the tooth groove on the last tumbler.

10. The linkage anti-theft lock head as set forth in claim 1, characterized in that the front tumblers are the following tumblers and the rear tumbler is the first tumbler. It can be described in detail that it comprises a lock tube, said lock tube comprising: axial grooves that are longitudinally symmetric, a circumferential groove, and a brake groove on the front end of the lock tube; a lock core with clearance fit provided between its outside diameter and the lock tube's corresponding inside diameter, said lock core comprising: a group of tumbler holes are distributed intervally and axially, a brake bar sliding groove formed axially and a through keyhole on the lock core; a brake bar forming clearance fit with said brake bar sliding groove, said brake bar comprising: a group of following brake teeth distributed intervally and longitudinally thereon and a first brake tooth, a boss is formed on the rear end of said brake bar, which forms clearance fit with said circumferential groove, and the brake end forms clearance fit with said brake groove at the front end of the brake bar; a group of following tumblers having clearance fits with the tumbler holes and having clearance fits with said axial grooves, said following tumblers comprising: tumbler keyholes formed on the center thereof, and at least one tooth groove is formed on each following tumbler; a first tumbler having clearance fit with the tumbler holes and having clearance fit with said axial grooves, said first tumbler comprising: a tumbler keyhole formed on the center thereof, and at least one tooth groove is formed on the first tumbler; a key that matches with the keyholes on the following tumblers and the keyhole on the first tumbler, said key comprising key teeth, the key teeth are formed by transition platforms, a pushing ramp and a back-pressure ramp, and transition connection is formed between the transition platform and the pushing ramp and the back-pressure ramp;
The symmetric surfaces of the brake bar sliding groove on the lock core intersect with the vertically symmetric surfaces of the lock core, and the symmetric surfaces of the brake bar sliding groove are located at the center of the tumbler hole height, the brake bar sliding groove on the lock core is open to the tumbler holes of the lock core;
The tooth grooves on the following tumblers are formed in the vertical center of the front planes of the following tumblers, said tooth grooves of the following tumblers have a right-angled triangle shape formed by the upper inclined plane and the bottom plane; the front planes of the following tumblers are perpendicular to the symmetric surfaces of the lock core, the openings of the tooth grooves of the following tumblers are configured to be in the same direction as the key insertion direction, the upper inclined planes and the bottom planes of the following brake teeth of the brake bar form an angle, and the following brake teeth on the rear portion of the brake bar engage with the tooth grooves of the following tumblers;
The tooth groove on the first tumbler is formed in the vertical center of the rear plane of the first tumbler, said tooth groove of the first tumbler has an angle formed by the upper inclined plane and the lower inclined plane, the back plane of the first tumbler is perpendicular to the symmetric surfaces of the lock core, the opening of the tooth groove of the first tumbler is configured to be in the reverse direction as the key insertion direction, a lobe is formed on the first brake tooth on said brake bar by the upper inclined plane and the lower inclined plane, and the first brake tooth engages with the tooth groove of the first tumbler.

11. The linkage anti-theft lock head as set forth in claim 10, characterized in that the tooth groove of said first tumbler has a shape of isosceles triangle, its upper inclined plane and lower inclined plane are symmetrical according to the angular bisector; said angular bisector of the upper inclined plane and the lower inclined plane is parallel to or on the same plane with the bottom planes of the tooth grooves of the following tumblers.

12. The linkage anti-theft lock head as set forth in claim 10, characterized in that the angle between the upper inclined plane of the above tooth groove of the following tumbler and the bottom plane of the tooth groove is 43°˜60°, the angle formed by the upper inclined plane of the following brake tooth and the bottom plane of the following brake tooth is 30°˜60°, and the bottom plane of the brake tooth is parallel to the bottom planes of the tooth grooves of the following tumblers; the tooth groove of said first tumbler has a shape of isosceles triangle, the angles formed by its upper and lower inclined planes and the angular bisector are 43°˜60°; the first brake tooth of said brake bar is toward the direction of the first tumbler, and the angles between the upper and lower inclined planes of the first brake tooth that form the lobe and the angular bisector are 30°˜60°.

13. The linkage anti-theft lock head as set forth in claim 10, characterized in that the angle between the upper inclined plane of said tooth groove of the following tumbler and the bottom plane of the tooth groove is 45°, and the angle formed by the upper inclined plane and the bottom plane of said following brake tooth of the brake bar is 45°; the tooth groove of said first tumbler has a shape of isosceles triangle, and the angles formed by its upper and lower inclined planes and the angular bisector are 45°; the first brake tooth of said brake bar is toward the direction of the first tumbler, and the angles between the upper and lower inclined planes of the first brake tooth and the angular bisector are 45°.

14. The linkage anti-theft lock head as set forth in claim 10, characterized in that the angle between the pushing ramp at the front end of the key and the key insertion direction is smaller than or equal to 45°.

15. The linkage anti-theft lock head as set forth in claim 10, characterized in that each of said following tumblers is provided with at least 2 tooth grooves that are uniformly arranged in parallel from up down, and the tooth grooves have the same direction, size and angle; in the unlocking state, the bottom plane of one of the tooth grooves on each following tumbler is on the same plane as the bottom plane of the following brake tooth of the brake bar.

16. The linkage anti-theft lock head as set forth in claim 10, characterized in that all transition platforms of said key are parallel to each other and parallel to the axis of the lock core.

17. The linkage anti-theft lock head as set forth in claim 10, characterized in that its unlocking and locking steps are, respectively:
The unlocking steps are as follows:
a. The process to unlock the following tumblers: the key is pushed forward. When the pushing ramp on the front end of the key props against the pressing surface of the keyhole on the first tumbler, all pressing surfaces of keyholes on the following tumblers are in the unlocking state of being pressed by transition platforms of the key, thereby achieving the primary unlocking of the following tumblers without linkage;
b. The process to unlock the first tumbler: the key is further pushed forward, and the pushing ramp on the front end of the key completes the process from propping against the pressing surface of the keyhole on the first tumbler to the complete pressing of the pressing surface of the keyhole on the first tumbler by a transition platform, such that the first tumbler moves downward and unlocks;
c. The process to unlock the brake bar: through the longitudinal movement of the first tumbler, at the same time, the upper inclined plane of the tooth groove on the first tumbler presses downwardly the upper inclined plane of the lobe of the first brake tooth of the brake bar, pushes the brake bar to move toward the following tumblers through the inclined plane, such that the brake end of the brake bar disengages from the brake groove on the bottom end of the lock tube, thereby achieving the secondary unlocking through linkage;
d. Along with the movement of the brake bar toward the following tumblers, at the same time, the following brake teeth of the brake bar mesh with the tooth grooves of the following tumblers;
The locking steps are as follows:
a. In the process of pulling the key, the key is first disengaged from the keyhole of the first tumbler, and the top end of the first tumbler enters the axial groove on the lock tube by means of a spring and returns to the locking position, thereby achieving the primary locking without linkage;
b. In the process of pulling the key, the key's back-pressure ramp drives one or several following tumblers thereof to move downward. While the following tumblers move downward, the upper inclined plane of the tooth groove on the following tumbler presses the following brake tooth of the brake bar, pushes the brake bar to move longitudinally toward the front end of the lock tube, such that the brake end of the brake bar engages with the brake groove on the front end of the lock tube, thereby achieving the secondary locking through linkage;
c. When the key is completely pulled out, the top end of the following tumbler enters the axial groove by means of a spring and achieves the primary locking without linkage together with the first tumbler;
d. When the brake bar enters the position of the brake groove, the lobe of the first brake tooth of the brake bar meshes with the tooth groove on the first tumbler.
